(19) United States
(12) Patent Application Publication
(10) Pub. No.: US 2009/0102193 A1
(43) Pub. Date: Apr. 23, 2009

(54) Fluid-driven electric generator for operatively connecting to a conduct carrying a fluid

(76) Inventor: Liam C. Murphy, Lake Groove, NY (US)

Correspondence Address: BERNARD S. HOFFMAN, 10 COLGATE STREET, PORT JEFFERSON STATION, NY, 11776, US

(21) Appl. No.: 11/975,866

(22) Filed: Oct. 22, 2007

(51) Int. Cl. H02P 9/04

(52) U.S. Cl. 290/43

(57) ABSTRACT

A fluid-driven electric generator for operatively connecting to a conduit carrying a fluid. The generator includes a driving portion and a generating portion. The driving portion is non-protrudingly positioned in the conduit so as to have its placement be non-visible from outside the conduit and is activated by the fluid flowing in the conduit. The generating portion is operatively connected to the driving portion and generates electricity when the driving portion is activated by the fluid flowing in the conduit.

### 1. BACKGROUND OF THE INVENTION

A. Field of the Invention

The embodiment of the present invention relate to a generator, and more particularly, the embodiments of the present invention relate to a fluid-driven electrical generator for operatively connecting to a conduit carrying a fluid.

B. Description of the Prior Art

Many problems currently exist for traditional power generation methods and systems. Approximately 95% of the world's supply of electrical energy is produced from non-renewable sources. Alternative fuels are not practical sources for taking care of all the worlds' electrical energy needs.

Global energy demand is increasing at approximately 2% per year. The Department of Energy has forecast that by the year 2020, the United States will need approximately 403 gigawatts and that the world will need approximately 3,500 gigawatts. Still, there are more than two billion people in the world who do not have access to electricity.

Demand for electricity is outrunning capacity, and the price mechanism is the essential way to restrain demand and encourage supply. Therefore, the cost of electricity will keep going up.

The current electricity rate structure for consumers penalizes the consumers who must pay for the fuel being used to generate either 18% or 22% energy conversion efficiency. In essence, the consumer is paying for some 500% of the actual cost of electricity by inherent transmission losses that are generated by the current power generation systems.

Hydro-energy conversion systems are desirable as an alternate method for generating electrical power from the energy available in residential and commercial water systems. Because, in many areas of the country, energy limitations cause brown outs or black outs, a need was felt for a system that could generate power while water was otherwise being used to wash clothing, watering the lawn, taking a shower, etc.

Numerous innovations for fluid-driven generators have been provided in the prior art, which will be described below in chronological order to show advancement in the art, and which are incorporated herein by reference thereto. Even though these innovations may be suitable for the specific individual purposes to which they address, they each differ in structure, and/or operation, and/or purpose from the embodiments of the present invention.

(1) U.S. Pat. No. 2,436,683 to Wood, Jr.

U.S. Pat. No. 2,436,683 issued to Wood, Jr. on Feb. 24, 1948 in class 290 and subclass 52 teaches a device for generating electrical energy actuated by the flow of fluid through a pipeline, including a housing adapted to form an integral stationary section of the line, bearing apparatus rigidly disposed axially of the housing, a rotor positioned on the bearing apparatus and adapted for operation while immersed in pipeline fluid, permanent magnets affixed to the periphery of the rotor to create a magnetic field, a stator surrounding the rotor and radially spaced therefrom, an insulating cylinder interposed between the stator and the rotor and provided with an internal shoulder and an external shoulder at the opposite end thereof, and apparatus for conducting electric current from the stator windings.

(2) U.S. Pat. No. 4,142,367 to Guisti.

U.S. Pat. No. 4,142,367 issued to Guisti on Mar. 6, 1979 in class 60 and subclass 325 teaches a fluid motor, including a rotatable output shaft, a fluid inlet, and a fluid outlet for serial connection in a domestic water system supply pipe. A rotary electrical generator is also provided and the output shaft of the fluid motor is drivingly coupled to the generator. A bank of storage batteries is further provided, and the generator includes a pair of electrical potential output conductors electrically connected to the bank of batteries through a current regulating structure, whereby the batteries may be recharged as a result of the fluid motor driving the generator. An auxiliary domestic electrical wiring system is electrically connected to the bank of storage batteries.

(3) U.S. Pat. No. 4,731,545 to Lerner et al.

U.S. Pat. No. 4,731,545 issued to Lerner et al. on Mar. 15, 1988 in class 290 and subclass 54 teaches a portable self-contained power conversion unit attached to an outlet of a pressurized fluid system, such as a nozzle of a garden hose. An impeller mounted in the body of the unit is rotated by the discharge of pressurized fluid through the unit. The rotational energy of the impeller is converted into electrical energy by a generator and/or used directly in rotating tools attached to the impeller, such as grinding wheels, rotary saws, rotary brushes, drill bits, and the like.

(4) U.S. Pat. No. 6,765,308 to Kazanjian et al.

U.S. Pat. No. 6,765,308 issued to Kazanjian et al. on Jul. 20, 2004 in class 290 and subclass 43 teaches a hydro-energy conversion system, including a hydraulic turbine rotor, a turbine housing being rotatably connected to the hydraulic turbine rotor, and a turbine cover being detachably connected to the turbine housing. A mounting flange is connected to the turbine housing. An input plumbing fitting is connected to the turbine housing. An output plumbing fitting is connected to the turbine housing. A generator is coupled to the hydraulic turbine rotor.

(5) U.S. Pat. No. 6,864,591 to DeFrank.

U.S. Pat. No. 6,864,591 issued to DeFrank on Mar. 8, 2005 in class 290 and subclass 1 R teaches an irrigation device, such as a sprinkler, including an electric generator for generating electricity. The sprinkler includes a nozzle coupled to a fluid conduit, a rotary deflector positioned downstream from the nozzle and within the atmosphere, an electric generator coupled to the rotary deflector, and a frame coupling the nozzle to the electric generator. The rotary deflector rotates about an axis as a fluid stream exiting the nozzle contacts and sprays from the rotary deflector. The rotary deflector and the rotor of the electric generator are coupled to a common axial shaft so that rotation of the rotary deflector translates to rotation of the rotor.

(6) U.S. Pat. No. 6,876,100 to Yumita.

U.S. Pat. No. 6,876,100 issued to Yumita on Apr. 5, 2005 in class 290 and subclass 54 teaches a small generator, including a hydraulic turbine provided in a fluid path rotating with a passage of a fluid in a predetermined flow and a rotator coupled to the hydraulic turbine rotating together with the hydraulic turbine acting as a rotor portion opposed to a stator portion having multiple layers in a stepping motor including the stator portion. The rotor portion relatively rotates with respect to the stator portion with the passage of the fluid, thereby generating power.

(7) U.S. Pat. No. 6,885,114 to Baarman et al.

U.S. Pat. No. 6,885,114 issued to Baarman et al. on Apr. 26, 2005 in class 290 and subclass 43 teaches a miniature hydro-power generation system producing electric power from a flow of liquid. The miniature hydropower generation system includes a housing including a plurality of paddles positioned to extend outwardly from an outer surface of the housing. The system also includes a nozzle and a centering rod extending through the housing. The housing rotates around the centering rod when a stream of liquid from the nozzle is directed at the paddles. A generator including a rotor and a stator is positioned within a cavity of the housing. The rotor is coupled with the housing, and the stator is coupled with the centering rod. The rotor rotates around the stator at a high RPM to generate electric power when the housing rotates. The electric power supplies a load and/or may be stored in an energy storage device.

### (8) United States Patent Application Publication Number 2005/0248161 to Heidel.

United States Patent Application Publication Number 2005/0248161 published to Heidel on Nov. 10, 2005 in class 290 and subclass 54 teaches attaching turbines to water mains, water towers, sewage lines, aqueducts, and various pipelines so as to capture the kinetic energy of pressurized fluid traveling through these mediums and changing the kinetic energy to electric energy by way of a generator, and conducting this new electricity to the nearest power substation by way of a conduction pipe. By consumer demand for utilities, such as water and sewage to be taken to and away from homes and businesses, these consumers will be making their own electricity that they will then buy back from the utility companies. With more and more people buying homes and starting businesses, there will be many new utility consumers on top of the already existing consumers.

### (9) United States Patent Application Publication Number 2006/0186669 to Ruggieri et al.

United States Patent Application Publication Number 2006/0186669 published to Ruggieri et al. on Aug. 24, 2006 in class 290 and subclass 2 teaches thermodynamic energy methods and systems providing all electrical energy and heat needs of a single residential house, commercial business, or office building. The system is small enough to be stored inside the house or building. The system can generate excess electrical energy that can be sold over a power grid and allow for the house owner, building owner, or energy utility company to receive income. The method and system can have a combined energy conversion efficiency of up to approximately 97%. Components include amorphous materials, and the mono-tube steam generator boiler, which is explosion proof when punctured, only emits a puff of steam when punctured. The tubes are built to pressure vessel code. Steam generators are used to power A/C units, domestic hot water, hot water air space heaters, and other loads, such as pools and spas and underground piping, to eliminate ice and snow. Additionally, vehicles are powered, such as cars and the like. Other embodiments use thermodynamic energy methods and systems providing electrical energy and heat needs of a residence, commercial business, or office building, including supertropically expanding ammonia vapor against a vacuum as generated by chemosorption in order to convert moderate amounts of heat into mechanical energy at high efficiencies. A supertropic package system includes a source of ammonia/water, a thermal generator for heating the source of ammonia/water and generating ammonia gas in response thereto, a positive displacement device for expanding the gas, and generating electricity from a power source driven by the expander.

(10) U.S. Pat. No. 7,121,495 to Caamano.

U.S. Pat. No. 7,121,495 issued to Caamano on Oct. 17, 2006 in class 242 and subclass 390.5 teaches a generator provided along a conduit carrying a man-made fluid flow. The generator generates electrical power that is, e.g., used to charge a battery, rotate a reel, or to directly control a fluid flow control valve associated with the fluid flow. In the garden hose context, neither AC power nor frequent battery replacement is required because power from the generator recharges the battery powering the valve and the reel.

It is apparent that numerous innovations for fluid-driven generators have been provided in the prior art that are adapted to be used. Furthermore, even though these innovations may be suitable for the specific individual purposes to which they address, they would not be suitable for the purposes of the embodiments of the present invention as heretofore described.

### 2. SUMMARY OF THE INVENTION

Thus, an object of the embodiments of the present invention is to provide a fluid-driven electric generator for operatively connecting to a conduit carrying a fluid, which avoids the disadvantages of the prior art.

Briefly stated, another object of the embodiments of the present invention is to provide a fluid-driven electric generator for operatively connecting to a conduit carrying a fluid. The fluid-driven electric generator includes a driving portion and a generating portion. The driving portion is non-protrudingly positioned in the conduit so as to have its placement be non-visible from outside the conduit and is activated by the fluid flowing in the conduit. The generating portion is operatively connected to the driving portion and generates electricity when the driving portion is activated by the fluid flowing in the conduit.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying drawing.

### 3. BRIEF DESCRIPTION OF THE DRAWING

The figures of the drawing are briefly described as follows:

FIG. 1 is a diagrammatic perspective view of the fluid-driven electric generator of the embodiments of the present invention operatively connected to a conduit carrying a fluid;

FIG. 2 is an enlarged diagrammatic perspective view with parts broken away of the driving portion of the fluid-driven electric generator of the embodiments of the present invention identified by ARROW 2 in FIG. 1; and

FIG. 3 is an enlarged diagrammatic perspective view with parts broken away of the generating portion of the fluid-driven electric generator of the embodiments of the present invention identified by ARROW 3 in FIG. 1.

### 4. LIST OF REFERENCE NUMERALS UTILIZED IN THE DRAWING

### A. General.

10 fluid-driven electric generator of embodiments of present invention for operatively connecting to conduit 12 carrying fluid 14
12 conduit
14 fluid carried by conduit 12

### B. Overall Configuration of Fluid-Driven Electric Generator 10.

16 driving portion
18 generating portion
20 electricity

### C. Specific Configuration of Driving Portion 16.

22 worm gear
24 mount

### D. Specific Configuration of Generating Portion 18.

26 clutch
28 flexible cable
30 gear drive
32 electric generator

### 5. DETAILED DESCRIPTION OF THE PREFERRED EMBODIMENTS

### A. General

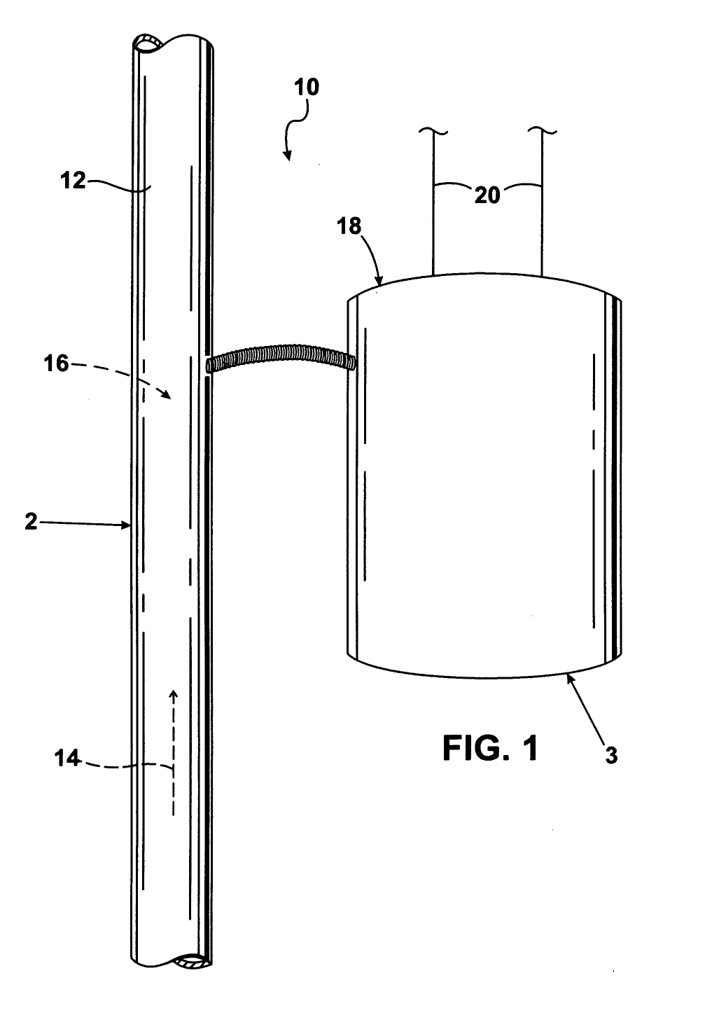

Referring now to the figures, in which like numerals indicate like parts, and particularly to FIG. 1, which is a diagrammatic perspective view of the fluid-driven electric generator of the embodiments of the present invention operatively connected to a conduit carrying a fluid, the fluid-driven electric generator of the embodiments of the present invention is shown generally at 10 for operatively connecting to a conduit 12 carrying a fluid 14.

### B. The Overall Configuration of the Electric Generator 10

The fluid driven electric generator 10 comprises a driving portion 16 and a generating portion 18. The driving portion 16 is non-protrudingly positioned in the conduit 12 so as to have its placement be non-visible from outside the conduit 12 and is activated by the fluid 14 flowing in the conduit 12. The generating portion 18 is operatively connected to the driving portion 16 and generates electricity 20 when the driving portion 16 is activated by the fluid 14 flowing in the conduit 12.

### C. The Specific Configuration of the Driving Portion 16

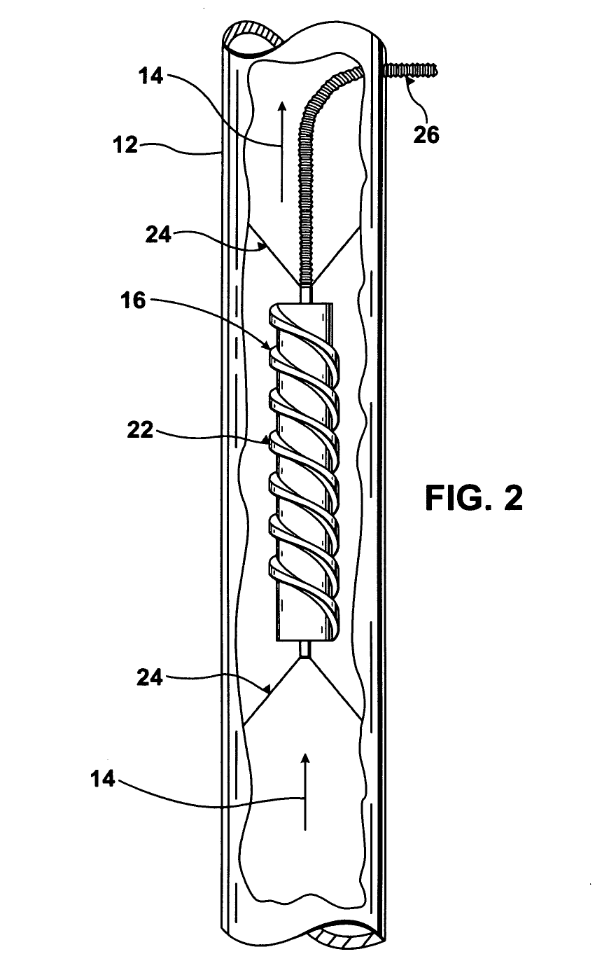

The specific configuration of the driving portion 16 can best be seen in FIG. 2, which is an enlarged diagrammatic perspective view with parts broken away of the driving portion of the electric generator of the embodiments of the present invention identified by ARROW 2 in FIG. 1, and as such, will be discussed with reference thereto.

The driving portion 16 comprises a worm gear 22. The worm gear 22 of the driving portion 16 is rotatably mounted axially in the conduit 12 so as to be non-protrudingly positioned in the conduit 12 so as to have its placement be non-visible from outside the conduit 12 and is rotated by the fluid 14 as the fluid 14 flows through the conduit 12.

The driving portion 16 further comprises a mount 24. The mount 24 of the driving portion 16 mounts the worm gear 22 of the driving portion 16 rotatably axially in the conduit 12.

### D. The Specific Configuration of the Generating Portion 18

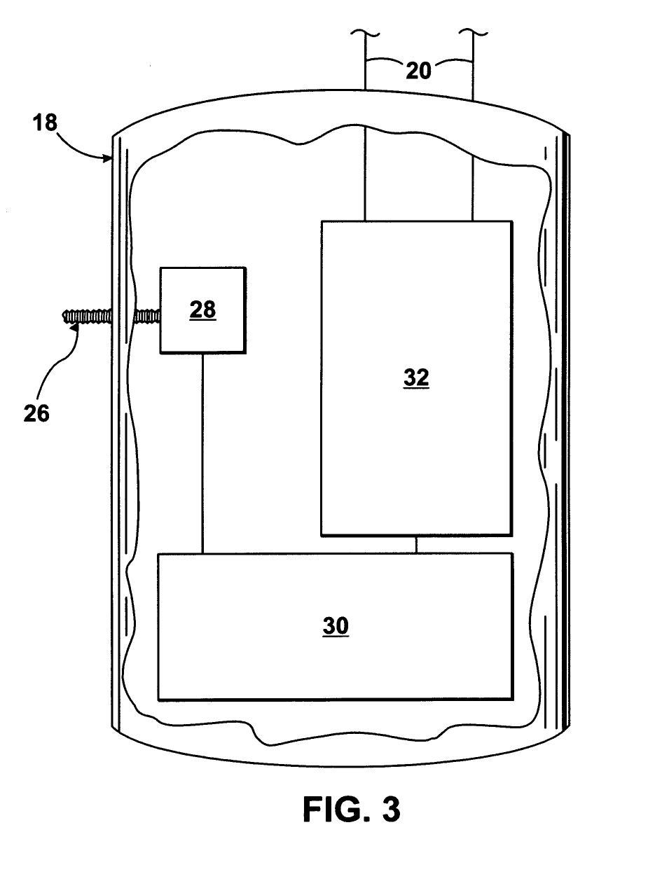

The specific configuration of the generating portion 18 can best be seen in FIG. 3, which is an enlarged diagrammatic perspective view with parts taken away of the generating portion of the electrical generator of the embodiments of the present invention identified by ARROW 3 in FIG. 1, and as such, will be discussed with reference thereto.

The generating portion 18 comprises a flexible cable 26. The flexible cable 26 of the generating portion 18 is operatively connected to the worm gear 22 of the driving portion 16.

The generating portion 18 further comprises a clutch 28. The clutch 28 of the generating portion 18 is operatively connected to the flexible cable 26 of the generating portion 18.

The generating portion 18 further comprises a gear drive 30. The gear drive 30 of the generating portion 18 is operatively connected to the clutch 26 of the generating portion 18 and activates when the clutch 26 of the generating portion 18 engages and deactivates when the clutch 26 of the generating portion 18 disengages.

The clutch 28 of the generating portion 18 engages when a preselected RPM of the worm gear 22 of the driving portion 16 is reached and disengages when another preselected RPM of the worm gear 22 of the driving portion 16 is reached.

The generating portion 18 further comprises an electric generator 32. The electric generator 32 of the generating portion 18 is operatively connected to the gear drive 30 of the generating portion 18 and generates the electricity 20 when the gear drive 30 of the generating portion 18 is activated by the clutch 26 of the generating portion 18.

### E. The Conclusions

It will be understood that each of the elements described above or two or more together may also find a useful application in other types of constructions differing from the types described above.

While the embodiments of the present invention have been illustrated and described as embodied in an electric generator for operatively connecting to a conduit carrying a fluid, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A fluid-driven electric generator for operatively connecting to a conduit carrying a fluid, comprising:
a) a driving portion; and
b) a generating portion;
wherein said driving portions is non-protrudingly positioned in the conduit so as to have its placement be non-visible from outside the conduit;
wherein said driving portions is activated by the fluid flowing in the conduit;
wherein said generating portions is operatively connected to said driving portion; and
wherein said generating portions generates electricity when said driving portion is activated by the fluid flowing in the conduit.

2. The fluid-driven electric generator of claim 1, wherein said driving portion comprises a worm gear;
wherein said worm gear of said driving portion is rotatably mounted axially in the conduit so as to be non-protrudingly positioned in the conduit so as to have its placement be non-visible from outside the conduit; and
wherein said worm gear of a said driving portion is rotated by the fluid as the fluid flows through the conduit.

3. The fluid-driven electric generator of claim 2, wherein said driving portion comprises a mount; and
wherein said mount of said driving portion mounts said worm gear of said driving portion rotatably axially in the conduit.

4. The fluid-driven electric generator of claim 2, wherein said generating portion comprises a flexible cable; and
wherein said flexible cable of said generating portion is operatively connected to said worm gear of said driving portion.

5. The fluid-driven electric generator of claim 4, wherein said generating portion comprises a clutch; and
wherein said clutch of said generating portion is operatively connected to said flexible cable of said generating portion.

6. The fluid-driven electric generator of claim 5, wherein said generating portion comprises a gear drive;
wherein said gear drive of said generating portion is operatively connected to said clutch of said generating portion;
wherein said gear drive of said generating portion activates when said clutch of said generating portion engages; and
wherein said gear drive of said generating portion deactivates when said clutch of said generating portion disengages.

7. The fluid-driven electric generator of claim 5, wherein said clutch of said generating portion engages when a preselected RPM of said worm gear of said driving portion is reached; and
wherein said clutch of said generating portion disengages when another preselected RPM of said worm gear of said driving portion is reached.

8. The fluid-driven electric generator of claim 6, wherein said generating portion comprises an electric generator;
wherein said electric generator of said generating portion is operatively connected to said gear drive of said generating portion; and
wherein said electric generator of said generating portion generates the electricity when said gear drive of said generating portion is activated by said clutch of said generating portion.
